(19) United States
(12) Patent Application Publication
(10) Pub. No.: US 2025/0172677 A1
(43) Pub. Date: May 29, 2025

(54) SONAR IMAGING TRANSDUCER DEPLOYMENT APPARATUS FOR A BOAT

(71) Applicant: Jordan P. Zelinsky, Domain (CA)

(72) Inventor: Delvin J. Kushniryk, Domain (CA)

(21) Appl. No.: 18/963,946

(22) Filed: Nov. 29, 2024

Related U.S. Application Data
(60) Provisional application No. 63/603,926, filed on Nov. 29, 2023.
(60) Provisional application No. 63/718,171, filed on Nov. 8, 2024.

(51) Int. Cl. G01S 7/521; G01S 15/89; G01S 15/96

(52) U.S. Cl. CPC G01S 7/521; G01S 15/89; G01S 15/96

(57) ABSTRACT

A deployment apparatus supports a sonar imaging transducer on a mounting pole that is movable relative to a mounting bracket mounted on a body of a boat using a linkage that moves the transducer on the pole from a deployed position in water to a stored position in which the transducer is elevated relative to the deployed position for transport. The pole may be pivoted or linearly slidable from the deployed position to the stored position under biasing from a spring. The linkage includes a catch that retains the pole in the deployed position against the bias until released by a rearward activation force acting on the bottom end of the pole. The biasing and the catch of the linkage allows the pole to be stowed automatically upon the boat moving forwardly across the water, eliminating the possibility of the transducer being damaged or lost due to failure to stow.

This application claims the benefits under 35 U.S.C. 119(e) of U.S. provisional application Ser. No. 63/603,926, filed Nov. 29, 2023 and U.S. provisional application Ser. No. 63/718,171, filed Nov. 8, 2024.

### FIELD OF THE INVENTION

The present invention relates to a deployment apparatus for supporting a sonar imaging transducer relative to a boat such that the transducer can be readily displaced between a deployed position in a body of water and a stored position raised relative to the deployed position to protect the transducer when the boat is travelling across the body of water.

### BACKGROUND

Sonar imaging devices are commonly used on boats for capturing data relating to the depth of the body of water and the presence of fish and the like in the body of water. The sonar images devices typically use a transducer for sending and receiving sonar pulses or beams in which the transducer may be operated between a deployed position in the water and a stored position on the boat to protect the transducer while the boat is travelling at high speed across the water. Currently a live imaging sonar transducer is deployed either on a trolling motor or an independent pole in order to be below the surface of the water and enables the fisherman to turn or view 360° around his boat. All present known applications involve the angler manually stowing or deploying in a hurried manner to move quickly between different fishing spots.

When the transducer is deployed on the shaft of a trolling motor, there is a problem for the angler to continue to view the live image from the sonar transducer if the boat needs to compensate in the wind or another situation that requires driving at the same time. When driving compensation occurs the live image view is disrupted.

Currently independent live imaging transducer poles are used; however, the angler must deploy and stow the pole every time the boat repositions locations. If the operator forgets to stow the transducer pole before speeding off to a new location, the transducer, live imaging pole, and boat will typically be damaged or lost, resulting in considerable cost to repair or replace. With regard to the boat for example, damage occurs when bolts and screws holding the mount in place are torn out of a fibreglass hull or the bracket will break.

### SUMMARY OF THE INVENTION

According to one aspect of the invention there is provided a transducer deployment apparatus for supporting a sonar imaging transducer relative to a boat on a body of water, the apparatus comprising:
a boat mounting bracket arranged to be mounted onto a body of the boat;
a mounting pole arranged to support the sonar imaging transducer on a bottom end of the mounting pole;
a linkage supporting the mounting pole relative to the boat mounting bracket such that the mounting pole is movable relative to the boat mounting bracket between a deployed position in which the bottom end of the mounting pole is arranged to be supported within the body of water and a stored position in which the bottom end of the mounting pole is raised in elevation relative to the deployed position; and
a biasing member acting on the linkage so as to bias the linkage towards the stored position from at least an intermediate position between the deployed position and the stored position;
the linkage being configured to retain the mounting pole in the deployed position against the bias of the biasing member; and
the linkage being releasable from the deployed position to the intermediate position responsive to a rearward activation force acting on the bottom end of the mounting pole in a rearward direction of the boat.

The deployment apparatus as descried above provides significant advantages over prior art transducer deployment arrangements. Specifically, the apparatus can be deployed from a remote or desired location in the boat when desired. The pole allows the transducer to be turned for approximately 360° viewing from the same remote or desired location. Furthermore, the biasing arrangement responsive to a rearward force on the transducer allows the mounting pole to be stowed automatically on its own upon the boat moving forwardly across the water, eliminating the possibility of being forgotten and damaged or lost due to failure to stow before take-off.

The linkage may be configured such that the rearward force must overcome the bias of the biasing member to displace the bottom end of the mounting pole in said rearward direction from the deployed position to the intermediate position.

According to some embodiments, the apparatus may further include a supporting collar mounted on the boat mounting bracket which supports the mounting pole to be longitudinally slidable therein between the stored position and the deployed position. The supporting collar is preferably pivotal relative to the boat mounting bracket about a lateral pivot axis as the bottom end of the mounting pole is displaced rearward from the deployed position to the intermediate position. The lateral pivot axis is preferably spaced forwardly of a longitudinal axis of the mounting pole.

The mounting pole may be supported on the boat mounting bracket for pivotal steering movement relative to the boat mounting bracket about a longitudinal axis of the mounting pole. In this instance, the apparatus may further include a steering collar receiving the mounting pole therein such that the mounting pole is longitudinally sliding relative to the steering collar and such that the mounting pole and the steering collar pivot together about the longitudinal axis of the mounting pole relative to the boat mounting bracket.

In some instances, a pulley cable may be operatively connected to the steering collar for controllably steering the mounting pole about said longitudinal axis.

Alternatively, a steering motor may be operatively connected to the steering collar to drive rotation of the steering collar in which the steering motor is responsive to left and right drive signals from a remote controller to drive rotation of the steering collar in opposing directions of rotation.

A handle member may be fixed to the mounting pole to protrude radially from the longitudinal axis of the mounting pole for manually steering the mounting pole about the longitudinal axis.

The apparatus may include a latching member fixed on the boat mounting bracket and defining a catch thereon which is arranged to retaining the mounting pole thereon against the biasing of the biasing member in the deployed position. The catch may be supported on boat mounting bracket at a location rearward of the mounting pole. In this instance, the mounting pole preferably includes a retainer edge arranged to be retained on the catch in the deployed position in which the retainer edge extends circumferentially about the mounting pole through a range of at least 300 degrees.

The latching member may include a cam surface formed thereon above the catch in which the cam surface is arranged to automatically deflect the mounting pole forwardly around the catch as the mounting pole is displaced downwardly from the stored position to the deployed position.

The apparatus may further include (i) a pull cable attached to the mounting pole above the boat mounting bracket at a first end of the pull cable and (ii) a cable guide on the boat mounting bracket receiving the pull cable thereon such that pulling a second end of the pull cable away from the boat mounting bracket acts to pull the mounting pole downwardly from the stored position to the deployed position.

According to some embodiments, the linkage may support the mounting pole for pivotal movement about a lateral axis from the deployed position in which the mounting pole is upright in orientation and the storage position in which the mounting pole is nearer to horizontal than vertical in orientation.

In this instance, the linkage may comprise: (i) a supporting assembly supported on the boat mounting bracket; (ii) a pole assembly coupled to the supporting assembly for relative pivotal about said lateral axis and being arranged to support the mounting pole thereon; (iii) a retainer edge formed on a first assembly among the supporting assembly and the pole assembly; and (iv) a catch member supported on a second assembly among the supporting assembly and the pole assembly; (v) wherein the biasing member acts to bias the bottom end of the mounting pole on the pole assembly in said rearward direction to pivot the pole assembly from the deployed position to the stored position; (vi) wherein the catch is movable relative to the second assembly from (a) a retaining position in which the catch member engages the retainer edge to resist displacement of the pole assembly from the deployed position to the storage position under action of the biasing member to (b) a release position in which the catch member is released from the retainer edge such that the pole assembly is displaced from the deployed position to the storage position under action of the biasing member; and (vii) wherein the catch member is movable from the retaining position to the release position responsive to said rearward activation force acting on the bottom end of the mounting pole.

The catch member may be supported on the supporting assembly and the retainer edge may be formed on the pole assembly.

The pole assembly may further comprises: (i) an intermediate body pivotally coupled on the supporting assembly for pivotal movement relative to the supporting assembly about the lateral axis; and (ii) a pole support body supporting the mounting pole thereon, the pole support body being pivotally supported on the intermediate body for relative pivotal movement about a release axis oriented parallel to the lateral axis such that the pole support body is pivotal between a first position allowing the catch member to be retained on the retainer edge in the retaining position and a second position engaging the catch member; (iii) wherein the catch member is displaced into the release position responsive to the pole support body being displaced from the first position to the second position; and (vi) wherein the pole support body is movable from the first position to the second position responsive to said rearward activation force acting on the bottom end of the mounting pole.

The apparatus may be further arranged such that: (i) the retainer member comprises a detent formed on the first assembly among the supporting assembly and the pole assembly; (ii) the catch member is axially slidable on the second assembly among the supporting assembly and the pole assembly between (a) the retaining position in which the catch member is at least partly received in the detent to resist displacement of the pole assembly from the deployed position to the storage position under action of the biasing member and (b) the release position in which the catch member is retracted from the detent; (iii) the catch member being biased towards the retaining position by a catch spring having a holding force acting to retain the catch member in the retaining position against the biasing member; and (vi) the holding force of the catch member is less than said rearward activation force whereby the catch member is movable to the release position responsive to said rearward activation force acting on the bottom end of the mounting pole.

### BRIEF DESCRIPTION OF THE DRAWINGS

Some embodiments of the invention will now be described in conjunction with the accompanying drawings in which:

FIG. 1 is rear elevational view of the transducer deployment apparatus according to a first embodiment of the present invention when supported on the transom of a boat in which the apparatus is shown in the stored position in solid line and in the deployed position in broken line;

FIGS. 2 and 3 are perspective views of the boating mounting bracket and the mounting pole of the apparatus according to the first embodiment of FIG. 1, shown in the stored position and the deployed position respectively;

FIGS. 4 and 5 are side and rear elevational views respectively of the boating mounting bracket and the mounting pole of the apparatus according to the first embodiment of FIG. 1, shown in the stored position;

FIGS. 6 and 7 are side and rear elevational views respectively of the boating mounting bracket and the mounting pole of the apparatus according to the first embodiment of FIG. 1, shown in the deployed position;

FIG. 8 is a schematic side view of the apparatus according to the first embodiment of FIG. 1, shown mounted on the transom of the boat in the deployed position;

FIG. 9 is a schematic rear view of the apparatus according to the first embodiment of FIG. 1, shown in the stored position;

FIG. 10 is a schematic top view of the apparatus according to the first embodiment of FIG. 1, shown in the stored position;

FIG. 11 is a front elevational view of a second embodiment of the apparatus according to the present invention, shown supported on a boat in the deployed position in solid line and in a transport position in broken line;

FIG. 12 is a perspective view of the apparatus according to the second embodiment of FIG. 11, shown in the deployed position;

FIG. 13 and FIG. 14 are side elevational views of the apparatus according to the second embodiment of FIG. 11, shown in the deployed position and in the storage position respectively;

FIG. 15 is a perspective view of a portion of the linkage of the apparatus according to the second embodiment of FIG. 11;

FIG. 16 is a perspective view of an intermediate body forming part of the pole supporting assembly of the linkage of the apparatus according to the second body meant of FIG. 11;

FIG. 17 is a perspective view of the pole support body forming part of the pole supporting assembly of the linkage of the apparatus according to the second embodiment of FIG. 11;

FIG. 18 is a sectional view of a portion of the linkage of the apparatus according to the second embodiment of FIG. 11;

FIG. 19 is a perspective view of the shaft body of the apparatus according to the second embodiment of FIG. 11;

FIGS. 20 and 21 are perspective and inside elevational views respectively of a tension body of the apparatus according to the second embodiment of FIG. 11;

FIGS. 22, 23, 24, 25 and 26 are outer side elevational, right side elevational, inner side elevational, top and bottom views respectively of a distal body of the apparatus according to the second embodiment of FIG. 11;

FIG. 27 is a perspective view of the apparatus according to third embodiment of the present invention, shown in the deployed position;

FIG. 28 is a front elevational view of the apparatus according to the third embodiment of FIG. 27;

FIG. 29 is a sectional view along the line 29-29 in FIG. 28;

FIG. 30 is a perspective view of the shaft body of the apparatus according to the third embodiment of FIG. 27;

FIG. 31 is an end elevational view of the shaft body of FIG. 30;

FIG. 32 and FIG. 33 are perspective and inner side elevational views respectively of the tension body of the apparatus according to the third embodiment of FIG. 27;

FIGS. 34, 35, 36 and 37 are perspective, right side elevational, top and inside elevational views respectively of a distal body of the apparatus according to the third embodiment of FIG. 27;

FIG. 38 is an inner side elevational view of the pole support body of the apparatus according to the third embodiment of FIG. 27; and

FIG. 39 is a top view of the pole support body of the apparatus according to the third embodiment of FIG. 27.

In the drawings like characters of reference indicate corresponding parts in the different figures.

### DETAILED DESCRIPTION

Referring to the accompanying figures, there is illustrated a sonar imaging transducer deployment apparatus generally indicated by reference numeral 10. The apparatus 10 is suited for supporting the transducer 12 of a sonar imaging system 14 relative to a boat 16 in a body of water such that the transducer can be readily displaced between a deployed position submerged in the body of water and a stored position in which the transducer is elevated from the deployed position to protect the transducer while the boat travels across the water.

A typical boat 16 includes a body 18 forming a hull which is tapered towards the front of the boat so as to be suitably shaped for cutting through waves and for riding up over the surface of the water at speed. The body of the boat 16 also includes a transom 20 at the rear of the boat forming a mount for a boat motor 22. The boat motor 22 is mounted onto the transom to propel the boat in the forward direction across the water. The body of the boat 16 also includes gunnels 23 extending longitudinally along each side of the boat forming an upper horizontal mounting surface adjacent a perimeter of the boat.

The sonar imaging system 14 includes a head controller 24 arranged to be mounted on the body of the boat at a suitable location for viewing by the operator of the boat. The head controller 24 is a computer controller having a memory storing programming instructions thereon and a processor arranged to execute the programming instructions to perform the basic functions of the imaging system as described herein. The transducer 12 of the imaging system 14 communicates with the head controller 24 such that the head controller directs the transducer to emit sonar beams or pulses and capture the reflected signals for communication back to the head controller for processing. The head controller generates image data based on the reflected signals captured by the transducer for subsequent display to an operator on a display screen of the head controller 24.

Although various embodiments of the apparatus 10 are shown in the accompany figures, in each instance the apparatus 10 generally includes (i) a boat mounting bracket 24 arranged to be fixedly mounted onto the body of the boat, (ii) a mounting pole 26 that supports the transducer on the bottom end of the pole, (iii) a linkage 28 supporting the mounting pole 26 on the bracket so that the transducer at the bottom of the pole can move between a deployed position protruding below the bottom of the boat and a stored position raised upwardly relative to the deployed position above the bottom of the boat, and (iv) a biasing member 30 operatively connected to the linkage 28 for biasing the mounting pole towards the stored position.

The linkage 28 cooperates with a retainer (or catch member) 32 that functions to hold the mounting pole in the deployed position against the bias of the spring until the linkage releases the mounting pole from the retainer. The retainer 32 is configured to release the mounting pole into the stored position under the force of the biasing member 30 only when the transducer on the bottom end of the mounting pole is urged rearwardly by an external force above a threshold amount, for example force of water pushing against the bottom end of the mounting pole when the boat is displaced forwardly across the water above a prescribed speed threshold. This allows the apparatus 10 to remain in the deployed position while the boat moves across the water slowly when trolling for example, while automatically retracting the transducer on the mounting pole into the stored position when the boat moves at higher speeds that would otherwise damage the mounting pole or the transducer.

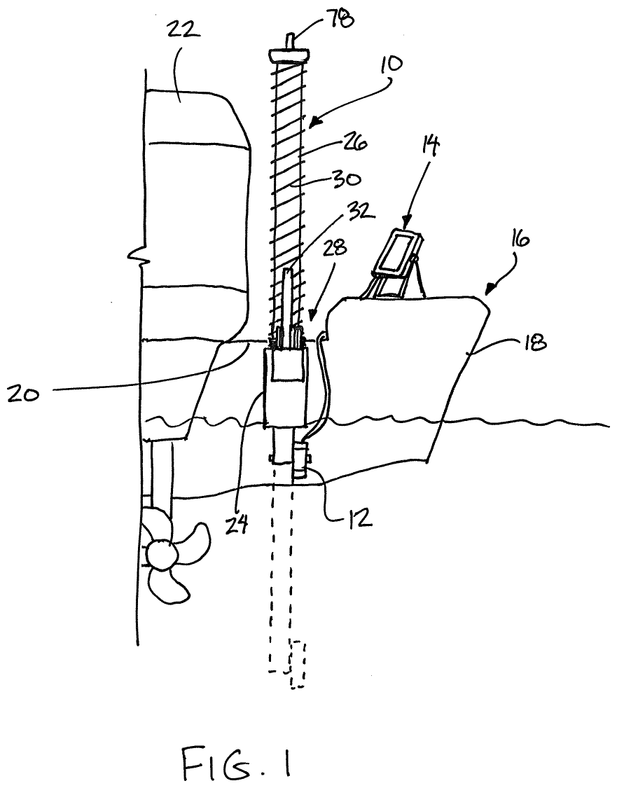

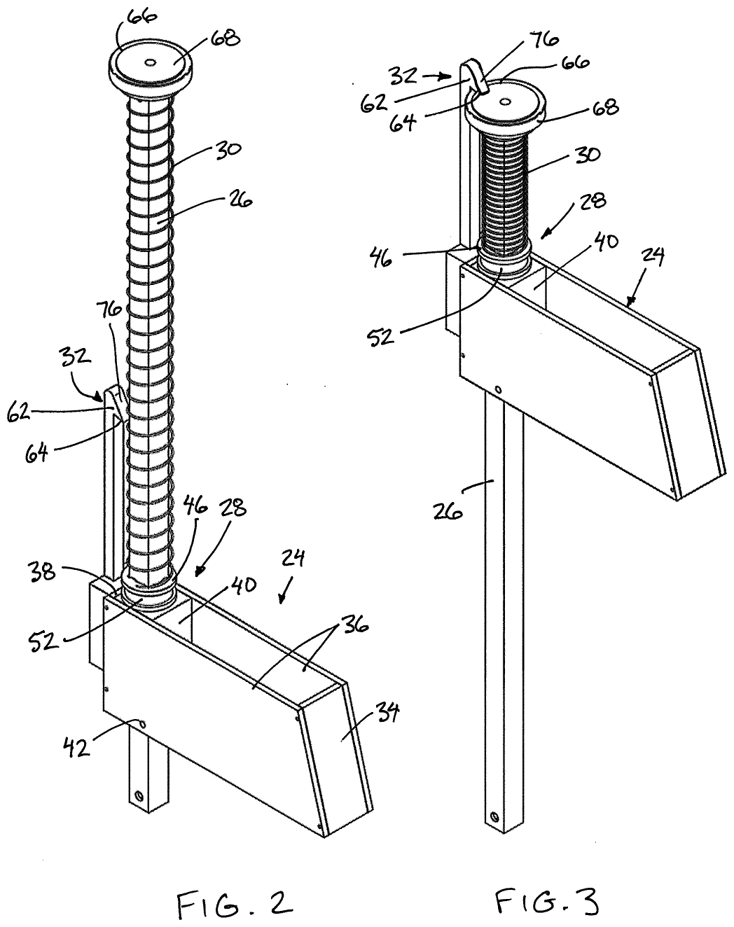

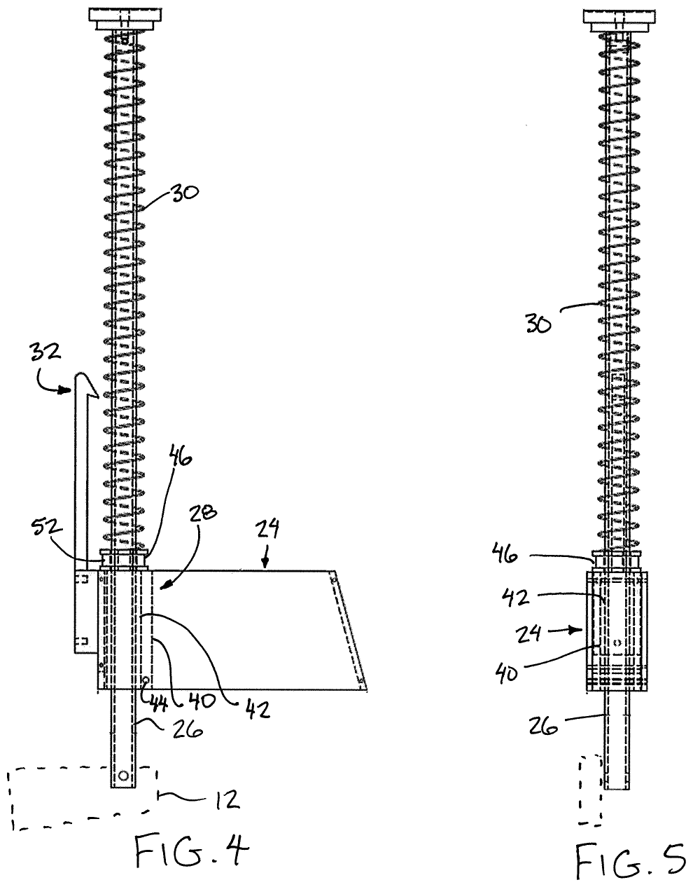

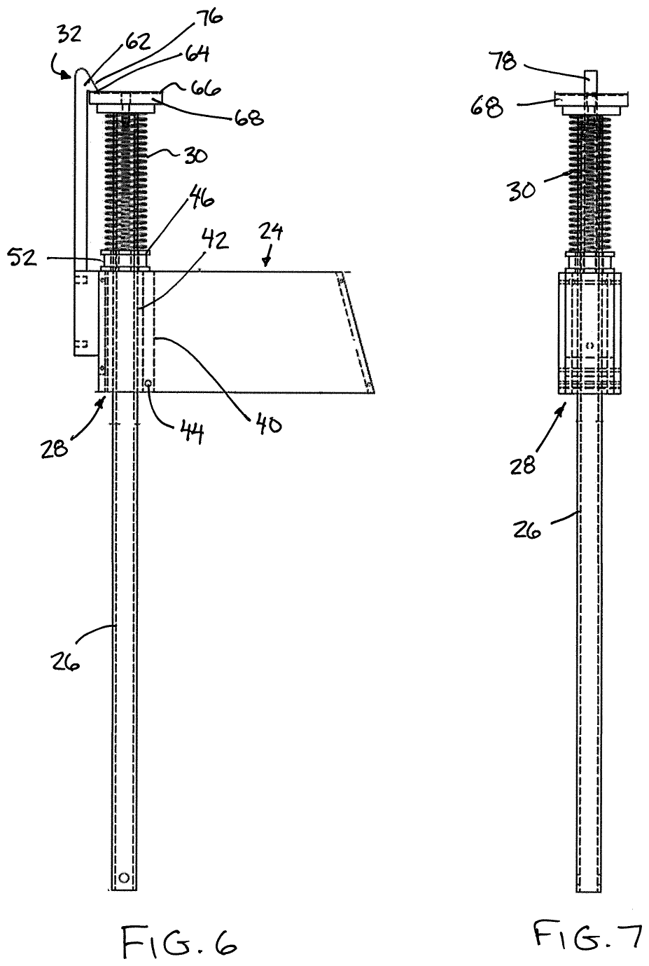

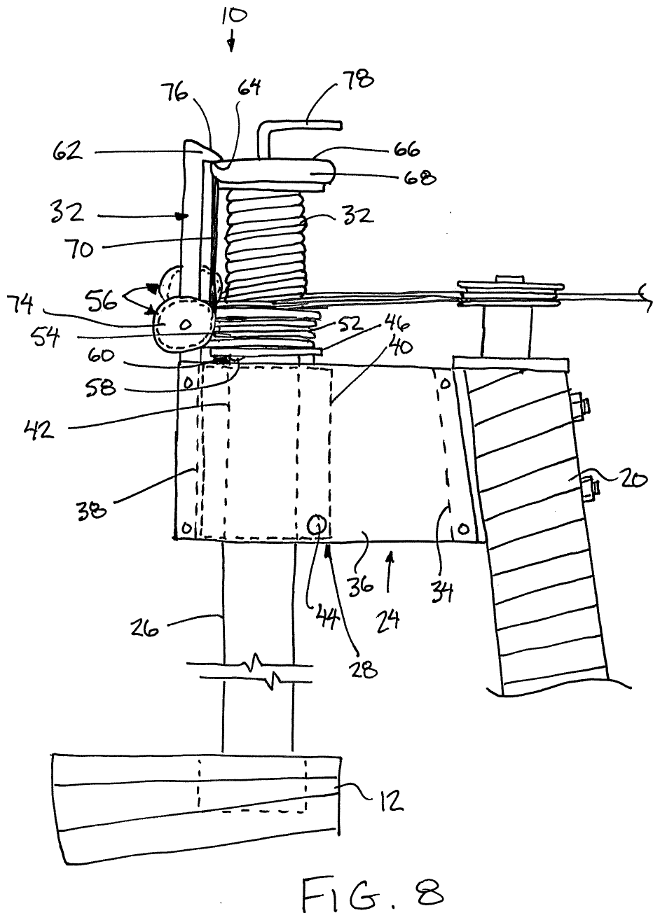

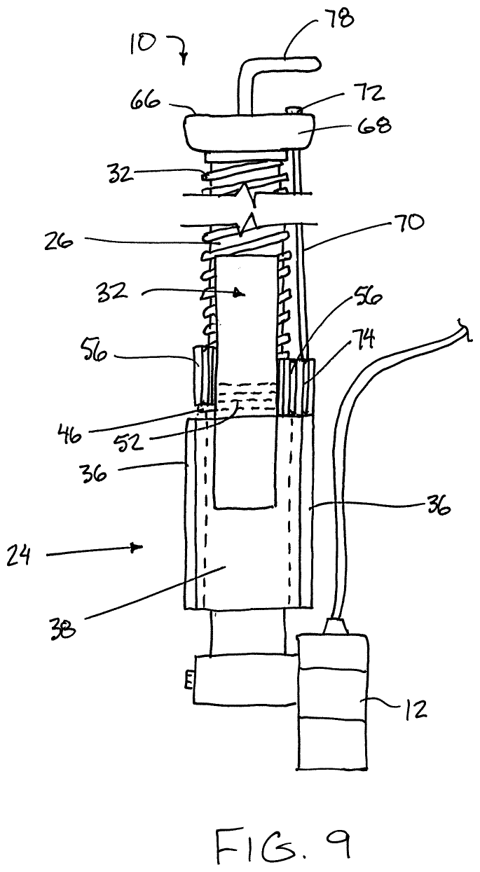

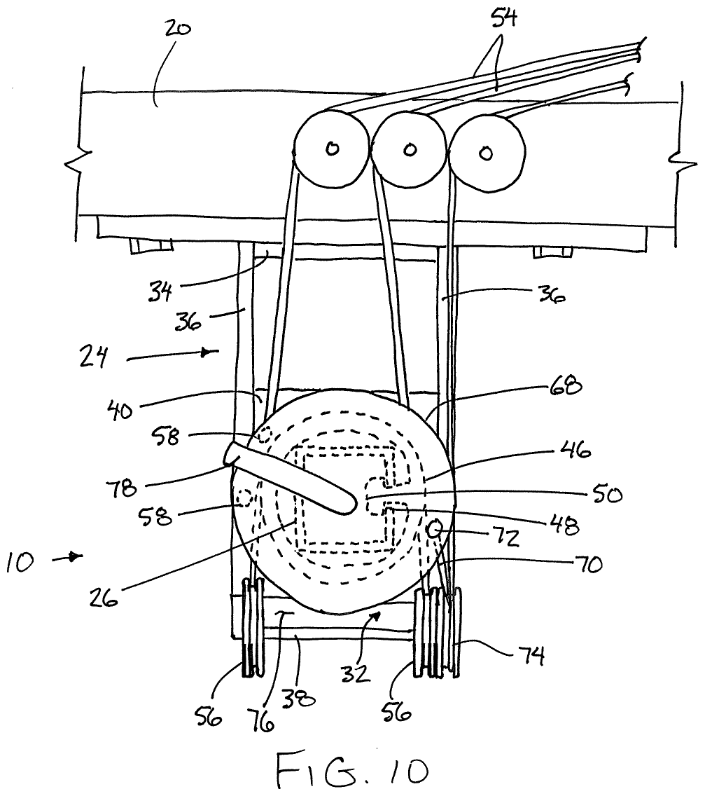

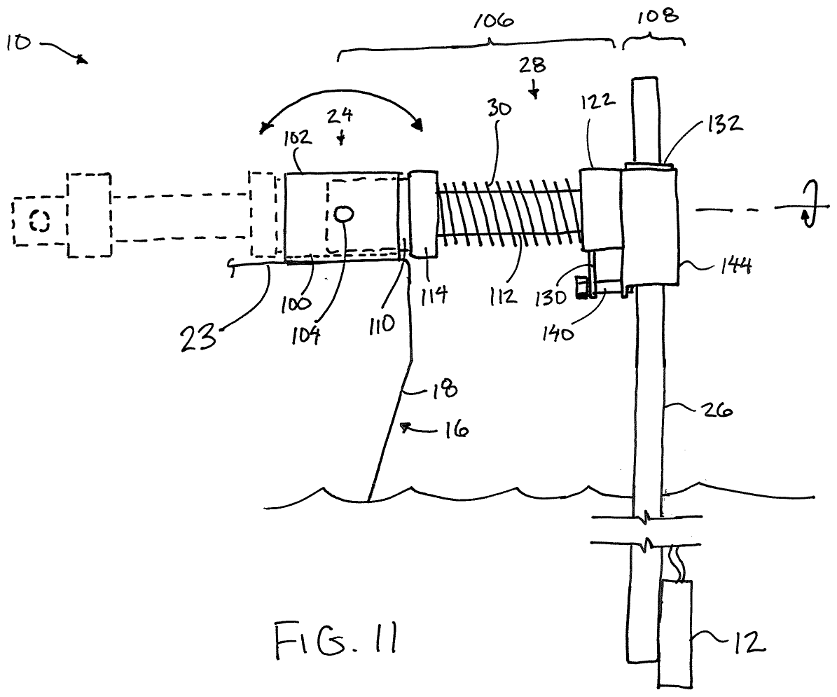

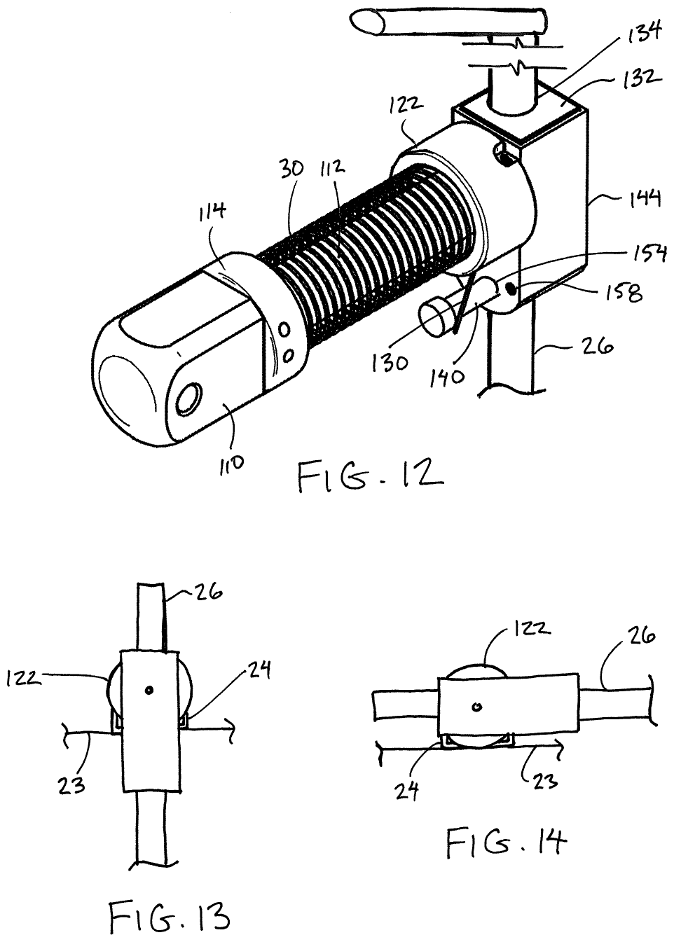

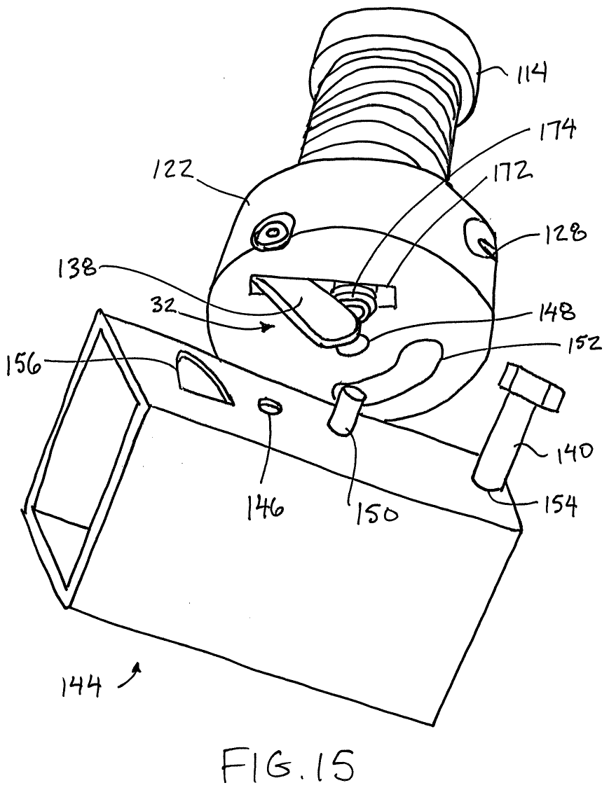

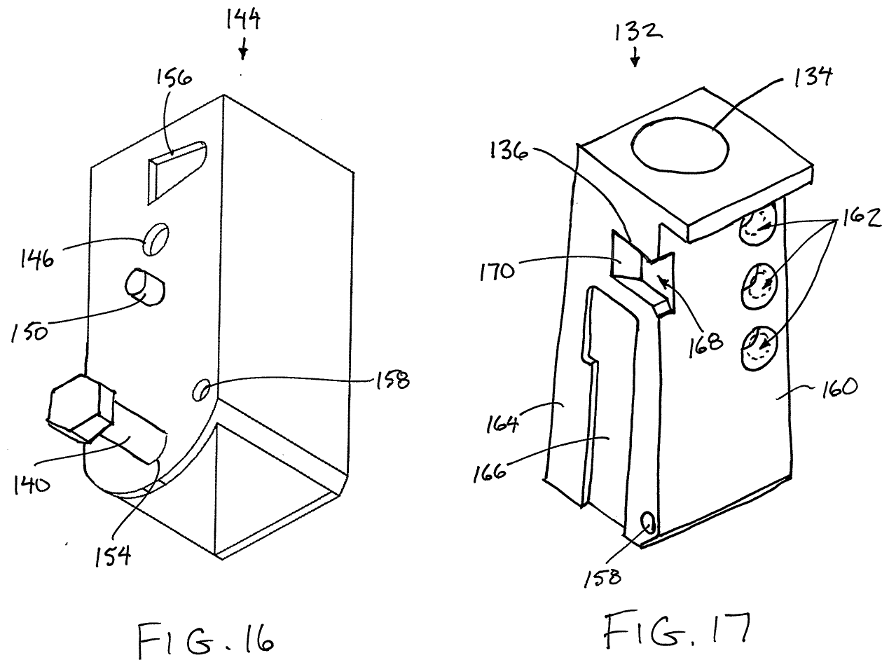

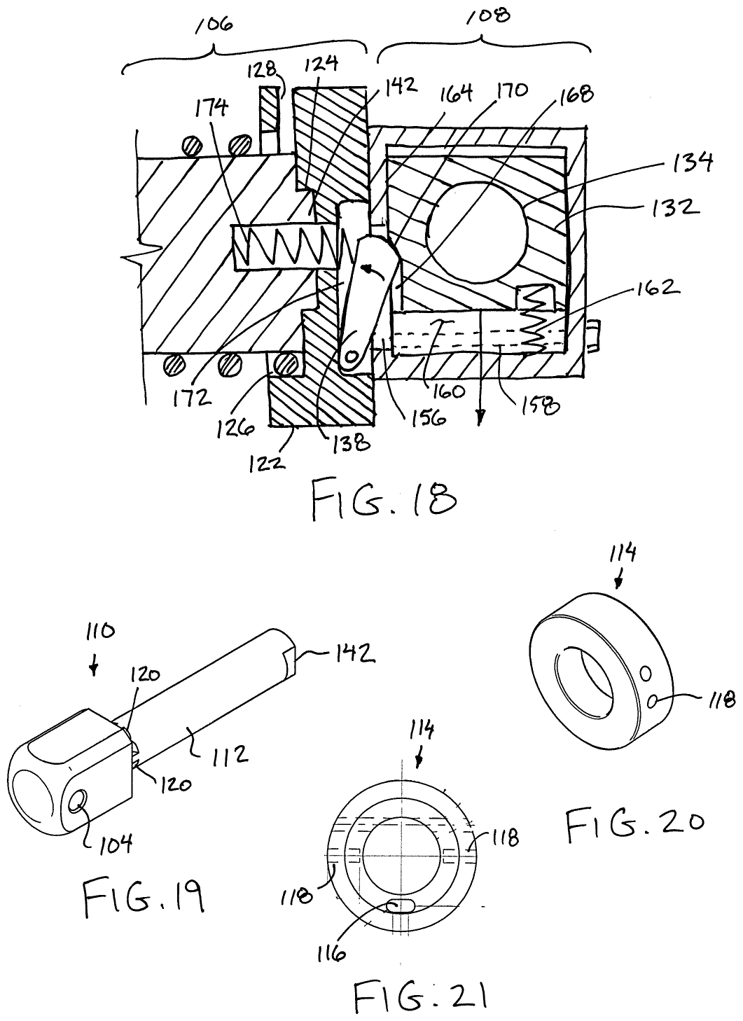

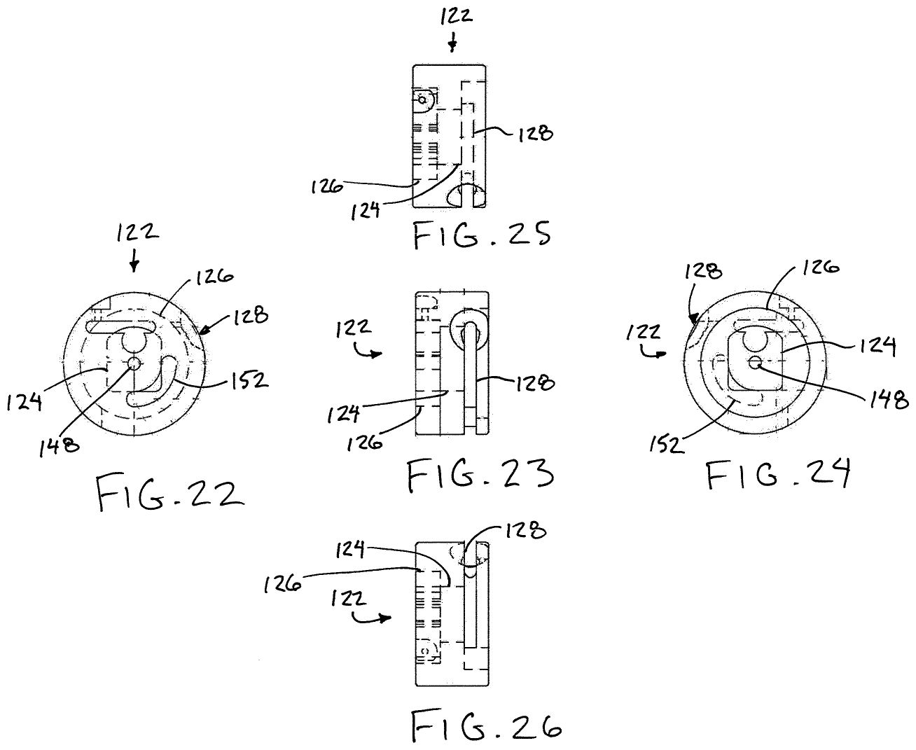

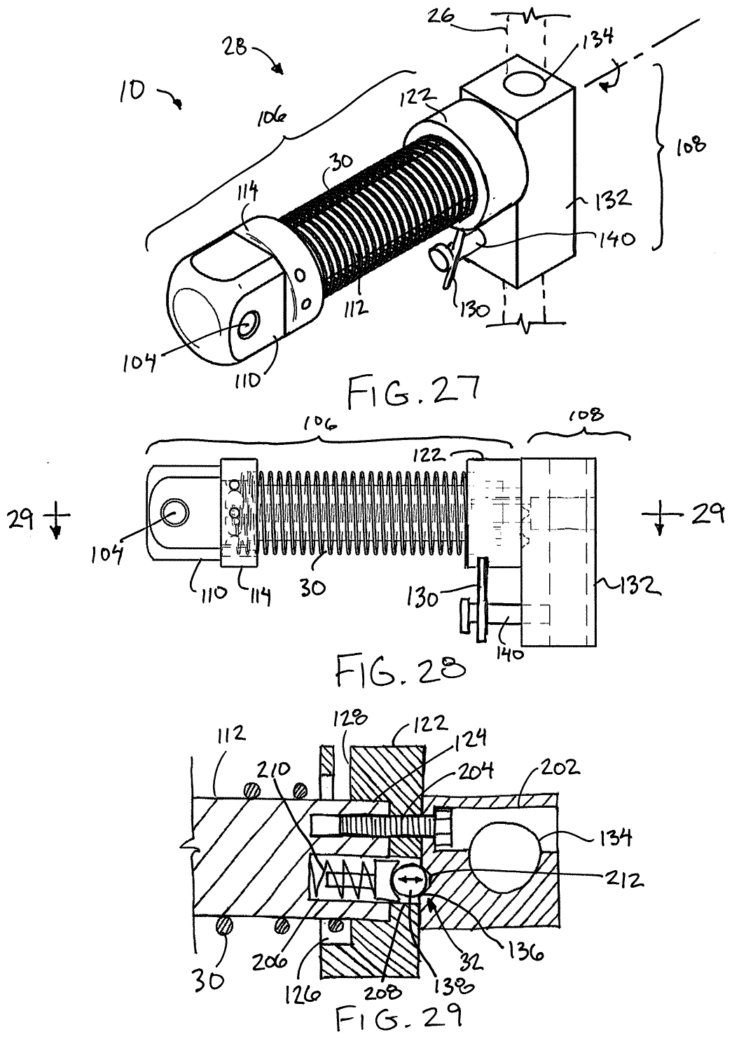

Turning now to the first embodiment shown in FIGS. 1 through 10, the mounting bracket 24 includes a front plate 34 which is flat and rectangular and locates fastener apertures therein so that the front plate 34 can be fastened flat against a rear surface of the transom 20 of the boat. A pair of side plates 36 extend rearward from opposing side edges of the front plate 34 so as to be parallel to one another. A rear plate 38 is coupled between the rear edges of the side plates 36 such that the overall structure of the bracket is generally rectangular in shape and rigid in the form of a sleeve defining a through passage between an open top and an open bottom of the bracket. The front plate 34 is sloped upwardly and rearwardly when the bottom edges of the side plates are generally horizontal in orientation such that the slope of the front plate 34 mates with the typical upward and rearward slope of the transom 20 at the rear of the boat.

The linkage 28 includes a supporting collar 40 in the form of a rigid rectangular block of plastic material that is received between the side plates 36 within the hollow interior of the bracket so as to substantially span the full width of the hollow interior between the side plates 36. The supporting collar 40 includes a round passage 42 extending vertically therethrough between opposing top and bottom ends of the support collar 40. The round passage 42 is suitably sized to receive the mounting pole 26 extending longitudinally therethrough. In the illustrated embodiment, the mounting pole has a square cross-section which is closely circumscribed by the round cross-section of the passage 42 so that the mounting pole is rotatable about a longitudinal axis of the pole relative to the supporting collar 40 while also being longitudinally slidable relative to the supporting collar along the longitudinal axis of the mounting pole.

The supporting collar 40 is pivotally coupled to the side plates 36 of the mounting bracket by pivotal couplings 44 for pivotal movement of the supporting collar 40 about a common lateral pivot axis of the pivot couplings 44. The pivot couplings 44 are located in proximity to the bottom of the supporting collar and the side plates of the mounting bracket while being spaced forwardly of the passage 42 adjacent a forward end of the supporting collar 40. The pivotal coupling allows the supporting collar to be pivoted through a range of a few degrees from the normal upright orientation in the deployed position. In the deployed position, a rear top edge of the supporting collar 40 abuts the rear plate 38 of the mounting bracket to prevent further downward and rearward pivotal movement of the supporting collar relative to the mounting bracket from the normal deployed orientation. The supporting collar 40 can be pivoted upwardly and forwardly from the normal deployed position above the lateral pivot axis by a few degrees in order to release the mounting pole from the retainer 32 as described in further detail below.

A steering collar 46 is provided immediately above the supporting collar 40 at a location above the top edges of the side plates 36 of the mounting bracket. The steering collar 46 includes a central passage receiving the mounting pole longitudinally slidable therethrough while being closely fitted to the mounting pole to locate the steering collar 46 concentrically with the mounting pole. The mounting pole includes a keyway 48 formed as a channel along one side of the mounting pole to extend the full length of the mounting pole. A corresponding key 50 is fixed relative to the steering collar to protrude into the central passage of the collar that receives the mounting pole therein such that the key fits within and mates with the keyway 48 in the mounting pole to couple the mounting pole for longitudinal sliding movement relative to the steering collar. In this manner the steering collar 46 and the pole can only rotate together about the longitudinal axis of the pole while allowing longitudinal sliding movement of the pole relative to the collar.

According to the illustrated embodiment, the steering collar 46 includes an annular groove 52 about the circumference of the collar such that the collar defines a pulley that receives a steering cable 54 within the annular groove to extend partway or fully about the circumference of the steering collar. A pair of steering idler pulleys 56 are mounted on the mounting bracket 24 at laterally opposing sides of the steering collar 46 to act as cable guides that receive respective portions of the steering cable 54 wrapped partway around the pulleys 56 at opposing sides of a central portion of the steering cable wrapped around the steering collar 46. The steering idler pulleys 56 are mounted on the mounting bracket rearward of the mounting pole and above the top side of the side plates 36 of the mounting bracket.

In this manner, the opposing ends of the steering cable 54 are free to extend forwardly from the steering idler pulleys 56 without interference for connection to a further arrangement of steering pulleys as may be desired for guiding the steering cable to an input member such as a steering wheel or steering handle that controls displacement of the steering cable to controllably pivot the steering collar 46 and the mounting pole connected thereto about the longitudinal axis of the pole that defines a steering axis of the apparatus 10. The operator of the boat can thus use the steering input member on the boat to steer the orientation of the transducer. Preferably the steering arrangement is capable of pivoting the mounting pole and the transducer mounted thereon through a range of at least 300°, and more preferably through a range of 360°. For example, when the sonar transducer provides an 18 degree wide beam, the steering collar may be configured to support the sonar imaging transducer to have 376 degrees of rotation to account for some overlap of live imaging.

In the illustrated embodiment, a pair of stops 58 are fixed on to the steering collar to protrude from the bottom thereof for engaging a corresponding stop 60 on the mounting bracket at the opposing ends of the range of pivotal movement of the steering collar relative to the mounting bracket when supported for rotation through a range of less than 360 degrees. A different arrangement of stops may be provided to allow for greater than 360 degree rotation according to the above example.

The retainer 32 comprises a rigid member which is fixed onto the rear plate 38 of the mounting bracket 24 to extend upwardly from the rear plate at a location rearward of the mounting pole 26. A hook 62 is formed at the top end of the retainer to protrude forwardly and define a bottom face that is generally horizontal and perpendicular to the longitudinal axis of the pole for defining a catch 64 that engages a corresponding surface on the mounting pole to retain the mounting pole in the deployed position.

The catch 64 cooperates with a retainer edge 66 formed on the top side of an annular flange 68 mounted on the top of the mounting pole 26. The annular flange 68 comprises a disc mounted onto the top of the rectangular cross-section of the mounting pole 26 such that the disc protrudes radially in all directions by being mounted concentrically relative to the pole. The top side of the disc forming the annular flange 68 defines the retainer edge thereon such that the retainer edge extends through at least the full range of motion of the steering collar. In the illustrated embodiment, the retainer edge 66 extend 360° about the full circumference of the mounting pole. The retainer edge 66 is received below the catch 64 of the retainer 32 in the deployed position to prevent upward displacement of the mounting pole from the deployed position to the stored position while still enabling the mounting pole to be pivoted through a range of steering movement by rotating the annular flange relative to the catch 64.

The bias member 30 comprises a helical spring mounted about the mounting pole while being axially under compression between the steering collar 46 at the bottom end of the bias member and the annular flange 68 at the top end of the bias member. The steering collar 46 is thus held firmly against the top side of the supporting collar 40 on the mounting bracket by the compression of the bias member which pushes downward on the steering collar 46 with the same force that the bias member pushes upwardly on the annular flange 68 to urge the mounting pole upwards to the stored position. Sliding the pole downward to the deployed position functions to compress the bias member. Even once the deployed position is reached, some ability to further compress the bias member remains. In this manner, in the deployed position, the supporting collar 40 pivoted at the pivot couplings 44 relative to the mounting bracket can be pivoted slightly upwardly and forwardly against the compression force of the bias member to pivot the top end of the mounting pole forwardly by a sufficient degree to release the retainer edge 66 from the catch 64 on the retainer 32.

To readily set the apparatus 10 in the deployed position, a deployment cable 70 may be used to quickly pull the mounting pole downward from the stored position to the deployed position. The deployment cable 70 is attached at a first end 72 on the annular flange 68 at the top of the mounting pole, preferably towards the rear of the mounting pole in a forward orientation of the transducer on the mounting pole. The deployment cable 70 extends downwardly alongside the mounting pole and then is wrapped at least partway about a deployment idler pulley 74 that is pivotally supported on the mounting bracket 24 adjacent one of the steering idler pulleys. The deployment idler pulley 74 is freely rotatable relative to the mounting bracket and functions as a cable guide to guide the deployment cable 70 forwardly to an opposing second end of the deployment cable 70 located at a remote location spaced from the mounting bracket. In this instance, the operator can pull on the second end of the deployment cable 70 to pull the deployment cable away from the mounting bracket which will in turn pull the first end of the deployment cable 70 downward for lowering the mounting pole from the stored position to the deployed position.

The retainer 32 mounted on the mounting bracket 24 also includes a cam surface 76 formed at the top side of the retainer which is sloped downwardly and forwardly in the same forward direction that the hook protrudes. The bottom surface of the annular flange 68 on the mounting pole also includes a tapered surface which is sloped downwardly and radially inwardly about the full circumference of the annular flange. When lowering the mounting pole from the stored position to the deployed position, the bottom surface of the annular flange 68 engages the cam surface 76 at the top of the retainer such that the mating sloped surfaces, upon engagement with one another, act to automatically deflect the top end of the pole forwardly which in turn deflects the retainer edge 66 on the mounting pole forwardly and around the catch 64 on the retainer. Once the annular flange 68 has been displaced past the catch 64 on the hook 62 of the retainer 32, the compression force acting on the supporting collar 40 and the steering collar 46 thereabove acts to push the supporting collar 40 back downwardly to its normal orientation from its deflected orientation which realigns the annular flange 68 below the catch 64. Continued biasing provided by the bias member 30 acts to firmly push the retainer edge of the mounting pole against the catch 64 to retain the mounting pole on the catch in the deployed position.

The apparatus 10 further includes a manual handle 78 mounted on the top side of the mounting pole above the annular retainer flange. The handle extends upward from a central location of the longitudinal axis of the mounting pole and then extends or protrudes radially outward from the longitudinal axis to define a handle suitable for gripping in the hand of a user to manually displace the mounting pole between the stored and deployed positions and to manually steer the mounting pole about the longitudinal steering axis relative to the mounting bracket 24 as may be desired. The direction of the manual handle 78 also provides a visual indication of the direction of the mounting pole and in turn the direction of the transducer mounted on the bottom end of the mounting pole.

In use, the operator attaches the mounting bracket 24 of the apparatus 10 to the transom or another suitable mounting surface on the boat such that the mounting bracket is fixed relative to the body of the boat. If it is desired to steer from a remote location, the steering cable is connected between the steering collar and an input steering member at a remote location on the boat. The transducer of the sonar imaging system is mounted on the bottom end of the mounting pole such that the transducer is rotated together with the mounting pole about the longitudinal steering axis of the mounting pole.

When the mounting pole is released from the catch 64 on the retainer 32, the bias member 30 biases the mounting pole upwardly to the stored position and holds the mounting pole in the stored position such that the transducer at the bottom of the mounting pole is higher in elevation than the bottom of the boat to protect the transducer and the mounting pole from damage when the boat is displaced across the water at high speeds. Once a desired fishing location has been reached and use of the sonar imaging system is desired, the operator quickly deploys the apparatus 10 into the deployed position by merely pulling the second end of the deployment cable away from the mounting bracket from the remote location on the boat where the operator is located.

Once deployed, the sonar imaging system can be used in the usual manner while steering of the orientation of the transducer is controlled using the steering cable or with the manual handle 78. The operator of the boat can perform normal operations such as trolling and the like without releasing the apparatus 10 from the deployed position. When it is desired to quickly move to a new location for fishing, the operator can simply operate the boat in the usual manner to advance the boat quickly across the body of water and the force of water pushing rearwardly against the bottom end of the mounting pole above the threshold holding force of the retainer will act to pivot the support collar upwardly and forwardly which in turn displaces the top end of the pole sufficiently forward to an intermediate position between the deployed position and the stored position to release the mounting pole from the catch 64 on the retainer. Once the mounting pole is displaced forwardly into the intermediate position so as to be released from the catch 64 of the retainer, the bias member acts to immediately push the top end of the mounting pole upward which displaces the mounting pole and the transducer thereon from the intermediate position to the stored position.

According to further embodiments, the steering collar 46 (and the connected mounting pole 26) may be controllably steered about the longitudinal axis of the mounting pole by a variety of methods other than the use of cables and pulleys. In one alternative embodiment of the apparatus 10, the steering collar 46 has circumferentially spaced apart gear teeth defining a spur gear in meshing relationship with a worm gear that is driven to rotate by a 12 volt electric motor that can be driven to rotate in either direction in response to control signals from a remote control (wired or wireless) using left and right buttons on the remote that cause the motor to drive rotation of the steering collar 46 in corresponding opposing directions of rotation. When using a worm gear drive, no stops 58/60 are required as the worm gear alone can define the range of rotation of the steering collar and mounting pole that support the transducer thereon.

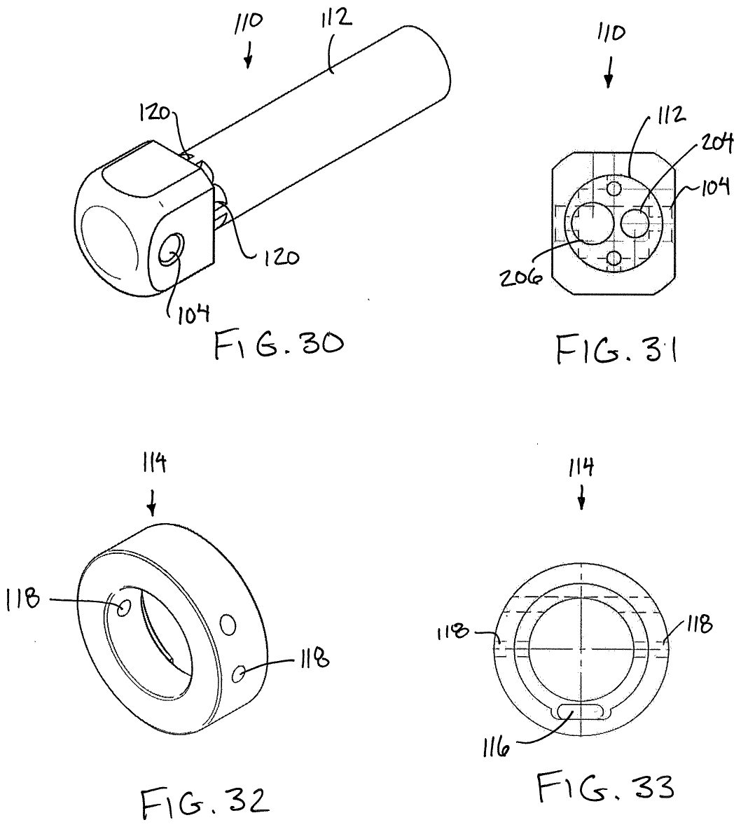

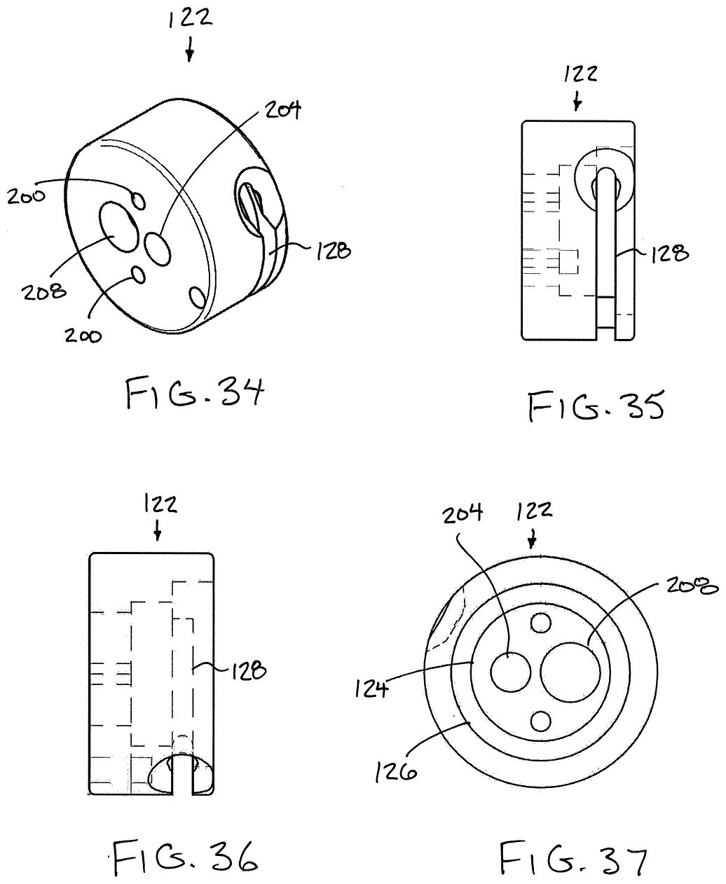

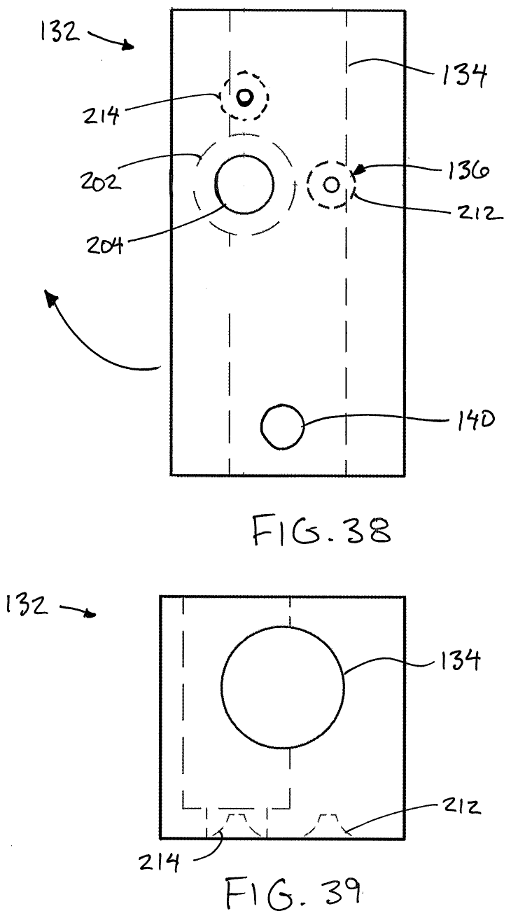

Turning now to a second embodiment shown in FIGS. 11 through 26 and a third embodiment shown in FIGS. 27 through 39, the common features of these additional embodiments will now be described. In each instance the boat mounting bracket 24 is arranged for mounting on upper horizontal surface corresponding to the gunnel 23 along either side of the boat 16. The apparatus 10 again comprises a linkage 28 supporting a mounting pole 26 in which the mounting pole carries a transducer 12 at the bottom end thereof for displacement between the deployed position and the stored position as described according to the previous embodiment.

The boat mounting bracket 24 in this instance is a generally U-shaped body comprised of a base plate 100 with fastener apertures for securing to the gunnel, and two side plates 102 extending upward from opposing side edges of the base plate so as to be parallel and spaced apart from one another for supporting a horizontal hinge pin 104 connected therebetween.

The linkage in this instance includes a supporting assembly 106 that is normally supported in a stationary manner on the boat mounting bracket 24 as the mounting pole is displaced between the storage and deployed positions, and a pole assembly 108 supporting the mounting pole 26 thereon such that the mounting pole is movable together with the pole assembly 108 for pivotal movement about a lateral axis relative to the supporting assembly between the storage and deployed positions. The lateral axis is typically oriented horizontally and perpendicularly to the forward working direction of the boat such that the mounting pole pivots with the pole assembly relative to the supporting assembly from the deployed position in which the mounting pole is upright and generally vertical in orientation and the storage position in which the mounting pole is substantially horizontal in orientation.

When the mounting pole is displaced into the stored position so as to be generally horizontally oriented, the entire supporting assembly 106 with the pole assembly and mounting pole supported thereon can be pivoted about the hinge pin 104 defining a pivot axis in the forward direction of the boat from a position protruding laterally outward to the exterior of the boat as shown in solid line in FIG. 11 to a transport position extending laterally inwardly into the interior of the boat as shown in broken line in FIG. 11 so that the apparatus 10 is more protected when the boat is moving at high speed across a body of water.

The supporting assembly 106 includes a shaft body 110 which is elongate in a direction of the lateral axis from a proximal end which is pivotally coupled on the boat mounting bracket 24 by the hinge pin 104 to an opposing distal end upon which the pole assembly 108 is supported. The shaft body includes an enlarged end portion at the proximal end which is rectangular in cross section for being received between the side plates of the boat mounting bracket 24. The shaft body further includes a cylindrical shaft portion 112 spanning a majority of the length of the shaft body to receive the biasing member 30 mounted thereon in the assembled configuration. The biasing member in this instance comprises a torsion spring which is helically wound about the cylindrical shaft portion 112 of the shaft body 110.

The apparatus 10 further includes a tension body 114 which is annular in shape and is mounted onto the shaft portion 112 adjacent the proximal end thereof. The tension body includes an axial socket 116 formed in an inner face of the tension body that receives an end of the torsion spring of the biasing member 30 inserted axially therein so that the proximal end of the torsion spring is fixed non-rotatably with the tension body 114. Radial fastener apertures 118 are internally threaded to receive one or more set screws which can be screwed into the tension body for selective engagement with corresponding stop recesses 120 formed in the cylindrical surface of the shaft portion 112 adjacent the proximal end thereof. By engaging the set screws, the tension body 114 can be locked against rotation relative to the shaft body, however, releasing the set screws allows the tension body to be rotated relative to the shaft body which in turn allows the torsional biasing force of the biasing member to be adjusted. Additional apertures in the outer circumference of the tension body 114 may be provided for insertion of a suitable tool to apply leverage for tensioning the spring by rotating the tension body 114 relative to the shaft body 110.

The apparatus 10 further includes a distal body 122 supported at the distal end of the shaft body 110. The distal body 122 is a cylindrical puck shaped body having a first bore 124 formed in the inner face that receives the end of the shaft body therein and a surrounding larger diameter counterbore 126 that is larger in diameter than the biasing member 30 so as to receive the end portion of the biasing member therein at the inner face of the distal body. One or more axially oriented fasteners are fastened through the distal body into the distal end of the shaft body to retain the distal body mounted on the shaft body. In this manner the biasing member 30 is effectively retained axially between the tension body at the proximal end of the shaft portion and the distal body 122 at the distal end of the shaft body.

A spring slot 128 communicates radially from the counterbore 126 to the exterior of the distal body to receive a leg portion 130 corresponding to the distal end of the torsion spring forming the biasing member 30. The leg 130 protrudes generally radially outward beyond the outer perimeter of the distal body for engaging a portion of the pole assembly 108 to transfer torsion and bias force from the biasing member 30 to the pole assembly 108 to drive pivotal movement of the biasing member from the deployed position to the storage position as described in further detail below. The spring slot 128 extends partway about the circumference of the distal body to allow the leg 130 of the spring to be rotated about the lateral axis through a range of at least 90° as the pole assembly 108 is displaced between the storage position and the deployed position.

The pole assembly 108 is pivotally supported on the distal body 122 at the end of the supporting assembly 106 such that the pole assembly is pivotal about the lateral axis relative to the supporting assembly 106. The pole assembly 108 includes a pole supporting body 132 in the form of a generally rectangular block of material having a through hole 134 extending vertically through the block when the block is in the deployed position such that the mounting pole 26 can be mounted within the hole 134. The mounting pole supports the transducer 12 at the bottom end thereof and may include a steering arm at the top end thereof such that the entire mounting pole can be pivoted about a longitudinal axis of the through hole 134 for optionally reorienting the transducer about a vertical steering axis if desired.

Each embodiment of the pole assembly 108 further includes a retainer edge 136 supported thereon which cooperates with a catch member 138 on the distal body 122 of the supporting assembly. The catch member 138 is generally movable in the axial direction of the lateral axis about which the mounting pole is pivoted between the deployed and storage positions relative to the supporting assembly. More particularly, the catch member is movable between (i) a retaining position in which a corresponding edge of the catch member is retained on the retainer edge 136 which holds the pole assembly against the biasing force of the biasing member 30 acting to displace the mounting pole from the deployed position to the storage position, and (ii) a release position in which the catch member is retracted into the boundaries of the distal body so as not to interfere with pivotal movement of the pole assembly from the deployed position to the storage position.

The pole assembly 108 also includes a spring connecting leg 140 supported thereon to protrude axially inward from an inner surface of the pole assembly at a location spaced below the lateral axis such that the leg is parallel to the lateral axis. In the deployed position, the leg is positioned adjacent the bottom of the pole assembly 108 so as to be in axial alignment with the leg portion 130 at the distal end of the biasing member 30 which is engaged upon the connecting leg 140 so as to act to transfer the bias and torsion of the biasing member 30 to the pole assembly and drive pivotal movement of the pole assembly through a range of 90° from the deployed position to the stored position.

Turning now more particularly to the second embodiment shown in FIGS. 11 through 26, the distal end of the shaft body 110 in this instance includes an end portion 140 which is noncircular in cross-section, for example having diametrically opposing parallel flat side edges. The mounting bore 124 at the inner side of the distal body 122 in this instance has a mating perimeter shape defining a socket that receives the end portion 142 of the shaft body therein such that the distal body 122 mates non-rotatably with the end of the shaft body 110. In this manner, a single central shoulder bolt can be mounted coaxially with the shaft portion through the distal body 122 to retain the distal body mounted on the shaft body without any relative rotation therebetween. The same shoulder bolt can also be used to fasten the pole assembly 108 onto the shaft body 110 through the distal body 122 such that the shoulder bolt defines the lateral axis about which the pole assembly is pivoted between the deployed and storage positions.

The pole assembly 108 in this instance includes an intermediate body 144 which couples the pole supporting body 132 onto the supporting assembly 106. The intermediate body 144 in this instance comprises a sleeve of rectangular cross-section formed of square tubing having a longitudinal axis generally aligned in the direction of the mounting pole. The hollow interior of the intermediate body 144 receives the generally rectangular block defining the pole supporting body 132 inserted vertically therein.

An inner wall of the intermediate body 144 nearest to the shaft body 110 includes a primary mounting hole 146 therein that receives the shoulder bolt for fastening the intermediate body 144 to the shaft body. The mounting hole 146 is aligned with a corresponding central hole 148 extending through the distal body that receives the shoulder bolt that simultaneously pivotally couples the pole assembly onto the supporting assembly while retaining the distal body 122 fastened onto the end of the shaft body 110.

The inner wall also mounts a protruding pin 150 thereon that extends axially inward and which aligns with an arcuate slot 152 in the end face of the distal body which extend through a range of 90° centred at the central hole 148. In this manner, the pin 150 of the pole assembly rides within the arcuate slot 152 of the supporting assembly 106 and the opposing ends of the slot act as stops which limit the overall range of movement between the deployed and storage positions respectively.

A threaded hole 154 at the bottom of the inner wall of the intermediate body 144 receives a bolt partly threaded into the hole so that the bolt protrudes axially inward to define the spring connecting leg 140 described above.

The inner wall of the intermediate body 144 further includes a retainer access hole 156 which receives the catch member therethrough such that the catch member 138 supported on the distal body 122 can interact with the retainer edge 136 which is located on the pole supporting body 132 received inside the intermediate body 144. The upper boundary edge of the retainer access hole 156 is sloped non-horizontally in the deployed position such that the upper edge does not act as a secondary retainer edge upon which the catch member may be retained to retain the apparatus in the deployed position inadvertently when it is not intended to.

The pole support body 132 in this instance is a generally rectangular block received inside the intermediate body so as to be coupled by a hinge pin 158 extending parallel to the lateral axis adjacent a bottom and front of the bodies in the deployed position. The hinge pin defines a release axis about which the pole supporting body 132 is pivotal through a range of a few degrees relative to the intermediate body 144 to release the catch member from the retaining position to the release position as described in further detail below. To allow some pivotal movement of the pole supporting body 132 relative to the intermediate body 144, a front face 160 of the pole supporting body is sloped upwardly and rearwardly away from the front wall of the intermediate body when the corresponding rear walls are situated in generally parallel relation to one another. The configuration of the pole supporting body and the front wall of the intermediate body adjacent the top end thereof being spaced apart allows the top end of the pole supporting body to be displaced forwardly relative to the intermediate body by pivoting about the release axis defined by the hinge pin 158.

A set of body springs 162 are partly received within corresponding sockets in the front face of the pole supporting body 132 adjacent to the top end thereof for axial compression between the pole supporting body 132 and the front wall of the intermediate body 144 acting to pivot the pole supporting body rearwardly at the top end thereof to a first position of the pole supporting body relative to the intermediate body 144 that corresponds to retaining the catch member 138 in the retaining position which in turn retains the pole supporting assembly 108 in the deployed position. Due to the mounting pole 126 being supported within the pole supporting body 132, a rearward force acting on the bottom end of the mounting pole below the release axis causes the top end of the pole supporting body 132 to be deflected forwardly relative to the intermediate body 144 against the bias of the body springs 162 from the first position to a second position of the pole support body to cause release of the catch member 138 as described in further detail below.

The pole supporting body 132 in this instance includes an inner face 164 oriented perpendicularly to the lateral axis and nearest to the supporting assembly 106 which locates a channel 166 recessed into the body of the pole supporting body in alignment with the shoulder bolt that mounts the intermediate body pivotally onto the supporting assembly 106. The channel 166 is suitably sized to receive the head of the shoulder bolt therein without interference to the displacement of the pole supporting body 132 as the body is inserted vertically downwardly into the intermediate body 144 during assembly as well as without interfering with pivotal movement of the pole supporting body 132 relative to the intermediate body 144 between the first position corresponding to the deployed position and an opposing second position in which the top-end is displaced forwardly against the body springs 162 to release the catch member and release the mounting pole into the storage position.

The pole supporting body 132 also defines the retainer edge 136 thereon as the upper boundary edge of a slot 168 formed in the inner face 164 that receives a portion of the catch member therein in the retaining position. The slot 168 is open to the front face of the pole supporting body 132 and extends rearward along the inner face so that the upper boundary is a horizontal undercut surface defining the retaining edge that retains the catch member 138 thereon in the retaining position. A rear end of the slot forming an inner terminal end of the slot distal from the front face of the pole supporting body is sloped to define a camming surface 170 where the depth of the slot relative to the inner face 164 is gradually reduced as the slot extends rearward to the inner rear end of the slot.

In the first position of the pole supporting body corresponding to the deployed position, the catch member is aligned with a forward portion of the slot 168 where the slot has the greatest depth in the direction of the lateral axis. As the pole supporting body 132 is pivoted forwardly relative to the surrounding intermediate body 144 when the mounting pole is subjected to the rearward activation force, the catch member is displaced rearwardly within the slot 168 towards the cam surface 170. The cam surface 170 acts to urge the catch member 138 out of the slot 168 and off of the retainer edge forming the upper boundary of the slot 168 so that the catch member is displaced to the release position retracted in the direction of the lateral axis into the distal body 122 in noninterference with the pole assembly. The pole assembly is then subsequently pivoted from the deployed position to the storage position under force of the biasing member 30.

The catch member 138 according to the second embodiment is a generally flat plate member which is elongated and includes a flat upper surface forming a suitable edge arrange to be retained on the retainer edge in the retaining position. The catch member is received within a catch recess 172 formed within the outer face of the distal body 122 so as to be pivotally coupled by a vertical pivot pin at one end of the catch member corresponding to one end of the recess such that the opposing and is movable relative to the outer face of the distal body generally in the direction of the lateral axis. The catch member is movable in the direction of the lateral axis from a protruding position corresponding to the retaining position of the catch member to a retracted position corresponding to the release position of the catch member. A catch spring 174 in the form of an axially compressed coil spring is received within a suitable pocket formed within the distal body inwardly relative to the catch member such that the catch spring 174 pushes the catch member outwardly towards the retaining position. The cam surface 170 adjacent the retainer edge 138 instead act to urge the catch member 138 to be retracted back into the distal body 122 against the action of the catch spring 174 when triggering the release of the apparatus 10.

In order to assemble the apparatus according to the second embodiment, the tension body is first slid axially onto the shaft portion of the shaft body into axial abutment with the end portion at the proximal end, followed by mounting of the biasing member 30 and the distal body 122 onto the shaft portion. The shoulder bolt defining the lateral axis about which the pole assembly is pivoted is then fastened through the corresponding aperture in the inner wall of the intermediate body 144 such that the bolt also extends through a central aperture in the distal body 122 for threaded fastening into the distal end of the shaft body 110. With the catch member retracted into the release position, the pole support member with associated body springs can then be inserted downwardly into the open top end of the intermediate body 144 in the deployed position followed by coupling of the pole support body 132 with the intermediate body 144 by the hinge pin 158.

The mounting pole 26 can then be mounted within the corresponding through-hole in the pole support body 132. The tension body 114 can be rotated about the shaft body and then fixed in place using suitable set screws once the biasing member has been suitably tensioned so that the mounting pole is biased from the deployed position to the storage position. By pivoting of the mounting pole into the deployed position, the catch spring 174 will automatically deploy the catch member 172 to be biased into the retaining position which retains the mounting pole in the deployed position. The mounting pole will be retained in the deployed position until a rearward force acting on the bottom end of the mounting pole causes the pole supporting body 132 to be pivoted from the first position to the second position thereof against the bias of the body springs 162 which in turn causes the cam surface 172 urge the catch member 138 off of the retainer edge 136 to release the catch member to the release position, which in turn allows the biasing member 30 to automatically bias the mounting pole from the deployed position to the storage position. A rearward activation force acting on the bottom end of the mounting pole which exceeds the holding force of the body springs 162 is sufficient to allow the apparatus to be triggered from the deployed position to the storage position.

Turning now more particularly to the third embodiment shown in FIGS. 27 through 39, the distal end portion of the shaft body 110 in this instance remains circular in cross section and the mounting bore 124 of the distal body 122 receiving the end of the shaft body therein is also circular in cross section, however relative rotation between the distal body and the shaft body is instead prevented by use of suitable fasteners penetrated through off-axis fastener holes 200 in the distal body which are aligned with corresponding threaded bores in the distal end face of the shaft body.

The pole assembly 108 in the third embodiment does not require an intermediate body 144 in this instance and instead the pole supporting body 132 is directly pivotally coupled to the distal body 122 on the end of the shaft body 110. The pole supporting body in this instance is a single rectangular block which is elongated in the direction of the through-hole receiving the mounting pole 26 therein. A transverse counterbore 202 aligned with the lateral axis communicates laterally from the exterior side of the block towards the interior with a central through bore receiving a shoulder bolt 204 extending therethrough for fastening the pole supporting body 132 pivotally onto the distal body 122. The shoulder bolt 204 extends fully through the distal body for being threaded into a corresponding mounting hole in the end face of the shaft body 110. The through-hole in the pole supporting body 132 that receives the shoulder bolt 204 therethrough is not threaded such that the pole supporting body remains rotatable about the bolt relative to the supporting assembly. The shoulder bolt 204 is threaded into the end of the shaft body at a location offset laterally to one side from a central axis of the shaft portion of the shaft body 110.

The spring connecting leg 140 in this instance is threaded directly into the block of material forming the pole supporting body at the bottom end thereof in alignment with the leg of the biasing member 30 as described above.

According to the third embodiment, a second bore 206 is formed in the distal end of the shaft body 110 to support the catch member 138 therein. The bore 206 in the shaft body is aligned with a through-bore 208 extending through the distal body 122. The catch member in this instance includes a catch spring 210 in the form of a helical spring which is axially compressed in an axial direction of the bore for engaging a round ball defining the catch member. The round ball has a diameter approximately equal to the diameter of the bore with the spring being axially compressed between the catch member and the inner terminal end of the bore to bias the catch member to protrude outwardly from the through-bore in the distal body into engagement with the pole supporting body 132.

The retainer edge in this instance comprises a detent 212 formed in the inner side face of the pole supporting body 132 so as to be aligned with the catch member in the deployed position. The detent 212 is sized to partly receive the catch member therein in the retaining position of the catch member corresponding to the deployed position of the mounting pole. The bridging of the round ball defining the catch member to be partly received within the detent 212 and partly received within the through-bore 208 in the distal body acts to prevent pivotal movement of the pole supporting body 132 away from the deployed position towards the storage position. The catch spring 210 urges the catch member into the detent 212 with a sufficient holding force that the catch member remains in the retaining position holding the pole supporting member 132 in the deployed position against the biasing member 30 by exceeding the biasing force of the biasing member.

More particularly the holding force of the catch member in the retaining position exceeds the biasing force of the biasing member 30 by an additional force amount that is only slightly less than the required actuation force to be applied rearwardly to the bottom end of the mounting pole to trigger release of the apparatus into the storage position. Accordingly, when the prescribed actuation force is applied rearwardly to the bottom end of the mounting pole, the activation force together with the biasing force of the biasing member 30 will exceed the holding force of the catch member causing the catch member to be released into the release position, followed by automatic pivoting of the mounting pole from the deployed position to the storage position under force of the biasing member once the catch member has been released.

A second detent 214 is provided in the inner face of the pole supporting block at a location offset 90 degrees about the lateral axis from the detent 212. Accordingly the catch member 138 is aligned with the second detent in the storage position so that the bias of the catch member received in second detent in the storage position rigidly secures the pole assembly relative to the supporting assembly when it is desired to leave the apparatus stored securely in the storage position.

In all embodiments, the prescribed activation force acting rearwardly on the bottom end of the mounting pole in order to trigger release of the apparatus from the deployed position to the storage position is greater than the typical resistive force of water acting rearwardly on the transducer when the boat is displaced forwardly through the water at low speeds corresponding to trolling when fishing for instance; however, the prescribed activation force to trigger release of the apparatus is much less than the typical resistive force of water acting rearwardly on the transducer when the boat is displaced forwardly at normal transport speed exceeding a trolling speed. Accordingly, simply driving the boat forwardly at a normal transport speed is sufficient for the resistive force of water acting rearwardly on the transducer to trigger release of the apparatus to the storage position to prevent any damage to the transducer or the apparatus 10.

Since various modifications can be made in the invention as herein above described, and many apparently widely different embodiments of same made, it is intended that all matter contained in the accompanying specification shall be interpreted as illustrative only and not in a limiting sense.

1. A transducer deployment apparatus for supporting a sonar imaging transducer relative to a boat on a body of water, the apparatus comprising:
a boat mounting bracket arranged to be mounted onto a body of the boat;
a mounting pole arranged to support the sonar imaging transducer on a bottom end of the mounting pole;
a linkage supporting the mounting pole relative to the boat mounting bracket such that the mounting pole is movable relative to the boat mounting bracket between a deployed position in which the bottom end of the mounting pole is arranged to be supported within the body of water and a stored position in which the bottom end of the mounting pole is raised in elevation relative to the deployed position; and
a biasing member acting on the linkage so as to bias the linkage towards the stored position from at least an intermediate position between the deployed position and the stored position;
the linkage being configured to retain the mounting pole in the deployed position against the bias of the biasing member; and
the linkage being releasable from the deployed position to the intermediate position responsive to a rearward activation force acting on the bottom end of the mounting pole in a rearward direction of the boat.

2. The apparatus according to claim 1 wherein the linkage is configured such that the rearward force must overcome the bias of the biasing member to displace the bottom end of the mounting pole in said rearward direction from the deployed position to the intermediate position.

3. The apparatus according to claim 1 further comprising a supporting collar mounted on the boat mounting bracket and supporting the mounting pole to be longitudinally slidable therein between the stored position and the deployed position.

4. The apparatus according to claim 3 wherein the supporting collar is pivotal relative to the boat mounting bracket about a lateral pivot axis as the bottom end of the mounting pole is displaced rearward from the deployed position to the intermediate position.

5. The apparatus according to claim 4 wherein the lateral pivot axis is spaced forwardly of a longitudinal axis of the mounting pole.

6. The apparatus according to claim 1 wherein the mounting pole is supported on the boat mounting bracket for pivotal steering movement relative to the boat mounting bracket about a longitudinal axis of the mounting pole.

7. The apparatus according to claim 6 further comprising a steering collar receiving the mounting pole therein such that the mounting pole is longitudinally sliding relative to the steering collar and such that the mounting pole and the steering collar pivot together about the longitudinal axis of the mounting pole relative to the boat mounting bracket.

8. The apparatus according to claim 7 further comprising a pulley cable operatively connected to the steering collar for controllably steering the mounting pole about said longitudinal axis.

9. The apparatus according to claim 7 further comprising a steering motor operatively connected to the steering collar to drive rotation of the steering collar, and a remote controller, the steering motor being responsive to left and right drive signals from the remote controller to drive rotation of the steering collar in opposing directions of rotation.

10. The apparatus according to claim 7 further comprising a handle member fixed to the mounting pole to protrude radially from the longitudinal axis of the mounting pole for manually steering the mounting pole about the longitudinal axis.

11. The apparatus according to claim 1 further comprising a latching member fixed on the boat mounting bracket and defining a catch thereon which is arranged to retaining the mounting pole thereon against the biasing of the biasing member in the deployed position.

12. The apparatus according to claim 11 wherein the catch is supported on boat mounting bracket at a location rearward of the mounting pole.

13. The apparatus according to claim 11 wherein the mounting pole includes a retainer edge arranged to be retained on the catch in the deployed position, the retainer edge extending circumferentially about the mounting pole through a range of at least 300 degrees.

14. The apparatus according to claim 11 wherein the latching member includes a cam surface formed thereon above the catch, the cam surface being arranged to automatically deflect the mounting pole forwardly around the catch as the mounting pole is displaced downwardly from the stored position to the deployed position.

15. The apparatus according to claim 1 further comprising (i) a pull cable attached to the mounting pole above the boat mounting bracket at a first end of the pull cable and (ii) a cable guide on the boat mounting bracket receiving the pull cable thereon such that pulling a second end of the pull cable away from the boat mounting bracket acts to pull the mounting pole downwardly from the stored position to the deployed position.

16. The apparatus according to claim 1 wherein the linkage supports the mounting pole for pivotal movement about a lateral axis from the deployed position in which the mounting pole is upright in orientation and the storage position in which the mounting pole is nearer to horizontal than vertical in orientation.

17. The apparatus according to claim 16 wherein the linkage comprises:
a supporting assembly supported on the boat mounting bracket;
a pole assembly coupled to the supporting assembly for relative pivotal about said lateral axis and being arranged to support the mounting pole thereon;
a retainer edge formed on a first assembly among the supporting assembly and the pole assembly; and
a catch member supported on a second assembly among the supporting assembly and the pole assembly;
wherein the biasing member acts to bias the bottom end of the mounting pole on the pole assembly in said rearward direction to pivot the pole assembly from the deployed position to the stored position;
wherein the catch is movable relative to the second assembly from (i) a retaining position in which the catch member engages the retainer edge to resist displacement of the pole assembly from the deployed position to the storage position under action of the biasing member to (ii) a release position in which the catch member is released from the retainer edge such that the pole assembly is displaced from the deployed position to the storage position under action of the biasing member; and
wherein the catch member is movable from the retaining position to the release position responsive to said rearward activation force acting on the bottom end of the mounting pole.

18. The apparatus according to claim 17 wherein the catch member is supported on the supporting assembly and wherein the retainer edge is formed on the pole assembly.

19. The apparatus according to claim 18 wherein the pole assembly further comprises:
an intermediate body pivotally coupled on the supporting assembly for pivotal movement relative to the supporting assembly about the lateral axis; and
a pole support body supporting the mounting pole thereon, the pole support body being pivotally supported on the intermediate body for relative pivotal movement about a release axis oriented parallel to the lateral axis such that the pole support body is pivotal between a first position allowing the catch member to be retained on the retainer edge in the retaining position and a second position engaging the catch member;
wherein the catch member is displaced into the release position responsive to the pole support body being displaced from the first position to the second position; and
wherein the pole support body is movable from the first position to the second position responsive to said rearward activation force acting on the bottom end of the mounting pole.

20. The apparatus according to claim 17 wherein:
the retainer member comprises a detent formed on the first assembly among the supporting assembly and the pole assembly;
the catch member is axially slidable on the second assembly among the supporting assembly and the pole assembly between (i) the retaining position in which the catch member is at least partly received in the detent to resist displacement of the pole assembly from the deployed position to the storage position under action of the biasing member and (ii) the release position in which the catch member is retracted from the detent;
the catch member being biased towards the retaining position by a catch spring having a holding force acting to retain the catch member in the retaining position against the biasing member; and
the holding force of the catch member is less than said rearward activation force whereby the catch member is movable to the release position responsive to said rearward activation force acting on the bottom end of the mounting pole.
